(19) United States
(12) Patent Application Publication
(10) Pub. No.: US 2008/0122307 A1
(43) Pub. Date: May 29, 2008

(54) Electric motor

(76) Inventor: Donald A. Campbell, North Canton, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/820,533

(22) Filed: Jun. 20, 2007

Related U.S. Application Data
(60) Provisional application No. 60/816,703, filed on Jun. 27, 2006.

(51) Int. Cl. H02K 5/16; H02K 5/00; H02K 3/28

(52) U.S. Cl. 310/90; 310/198; 310/91

(57) ABSTRACT

An electric motor produces an increased output torque for a given amount of input electrical current by using two magnetic field parts adjacent a winding part. Preferably, the winding part is disposed between the field parts. In a first embodiment, the two field parts are radially spaced from one another with the winding part therebetween. One field part is mounted on a hollow post through which an output shaft extends and on which a bearing is mounted for rotatably supporting thereon the winding part. In a second embodiment, the field parts are axially spaced from one another with the winding part therebetween. Axially spaced mounting wheels are connected to the output shaft for supporting therebetween a plurality of windings. The third embodiment includes a plurality of output shafts and a rotor suspended by interaction between pinions on the shafts and rotor gears.

### CROSS REFERENCE TO RELATED APPLICATIONS

This application claims priority from U.S. Provisional Application Ser. No. 60/816,703 filed Jun. 27, 2006; the disclosure of which is incorporated herein by reference.

### BACKGROUND OF THE INVENTION

1. Technical Field

The present invention relates generally to electric motors. More particularly, the invention relates to electric motors utilizing a plurality of magnetic field parts in order to produce a greater amount of output torque for a given amount of input electrical current.

2. Background Information

Standard electrical motors utilize a stator and a rotor which is rotatably mounted thereon and which has a plurality of electrical windings thereon. Typically, the stator includes a field part having a plurality of magnets mounted thereon and surrounding the rotatable windings. Thus, through the use of a suitable brush assembly, an electrical current is passed through the windings which causes the rotor to rotate as a result of the windings being disposed within the magnetic field of the field part. While such motors have long been known in the art, there is a need for an electric motor which produces an increased degree of torque output in response to the amount of electrical input current. The present invention solves this and other problems within the art.

### BRIEF SUMMARY OF THE INVENTION

The present invention provides an electric motor comprising: a stator; a rotor rotatable relative to the stator; a winding part mounted on one of the stator and rotor and comprising an armature with a plurality of windings thereon; an annular outer surface on the winding part facing radially outwardly; an annular inner surface on the winding part facing radially inwardly; a first interior chamber defined by the annular inner surface; a first field part comprising a first set of magnets in the first interior chamber providing a magnetic field in which the windings are disposed; a second field part comprising a second set of magnets positioned radially outwardly of the annular outer surface providing a magnetic field in which the windings are disposed; and wherein the field parts are mounted on the other of the stator and rotor.

### BRIEF DESCRIPTION OF THE SEVERAL VIEWS OF THE DRAWINGS

FIG. 1 is a side elevational view of a first embodiment of the motor of the present invention.

FIG. 2 is an exploded side elevational view of the first embodiment.

FIG. 3 is a sectional view of the motor taken on line 3-3 of FIG. 4.

FIG. 4 is a sectional view taken on line 4-4 of FIG. 3.

FIG. 5 is a sectional view taken on line 5-5 of FIG. 3.

FIG. 6 is a sectional view taken on line 6-6 of FIG. 3.

FIG. 7 is an end elevational view of one of the laminations of the armature.

FIG. 8 is a sectional view taken on line 8-8 of FIG. 7.

FIG. 9 is a side elevational view of the second embodiment of the motor of the present invention.

FIG. 10 is an exploded side elevational view of the second embodiment.

FIG. 11 is a sectional view of the second embodiment taken from the side.

FIG. 11A is an enlarged sectional view of a portion of FIG. 11 showing the brush assembly and surrounding parts.

FIG. 12 is a sectional view taken on line 12-12 of FIG. 11.

FIG. 13 is a sectional view taken on line 13-13 of FIG. 12.

FIG. 14 is a sectional view taken on line 14-14 of FIG. 11.

FIG. 15 is a sectional view taken on line 15-15 of FIG. 11.

FIG. 16 is a sectional view taken on line 16-16 of FIG. 11A.

FIG. 17 is a sectional view taken on line 17-17 of FIG. 11.

FIG. 18 is a side elevational view of a third embodiment of the motor of the present invention.

FIG. 19 is a sectional view of the third embodiment similar to FIG. 3.

FIG. 20 is a sectional view taken on line 20-20 of FIG. 19.

Similar numbers refer to similar parts throughout the drawings.

### DETAILED DESCRIPTION OF THE INVENTION

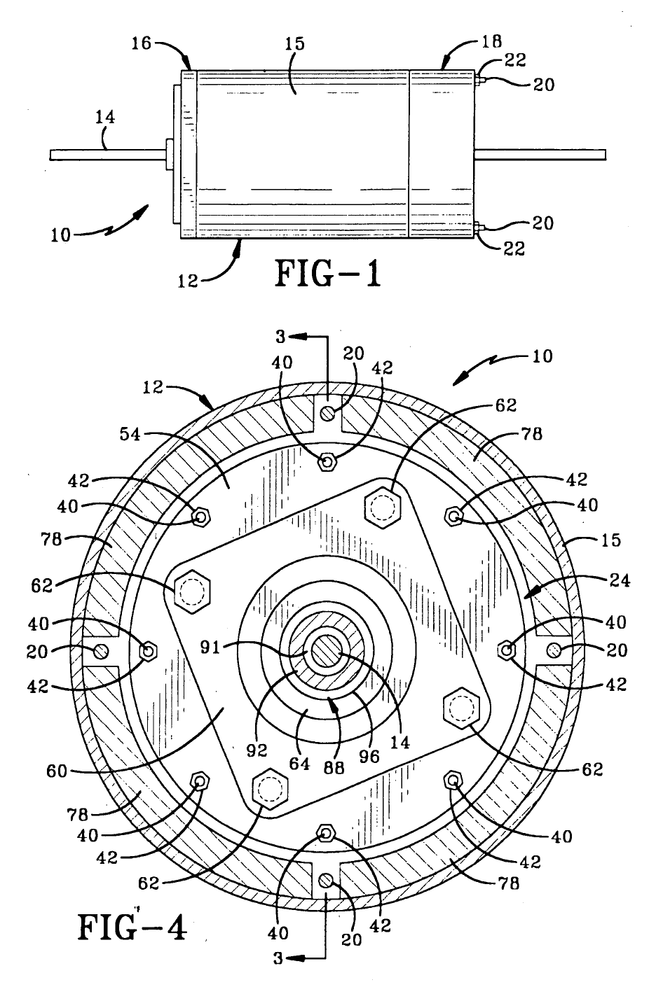

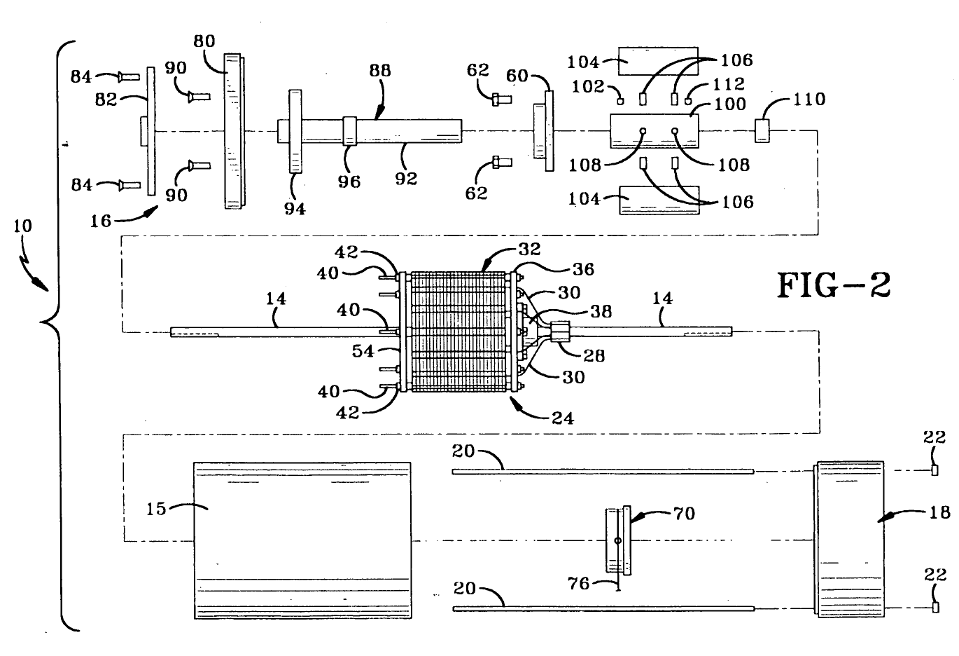

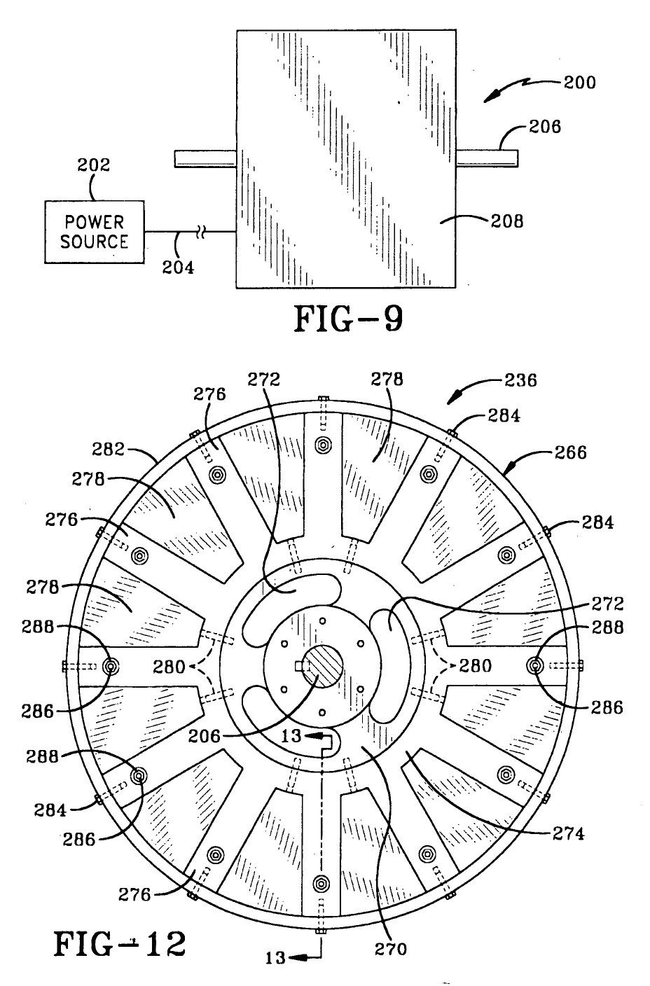

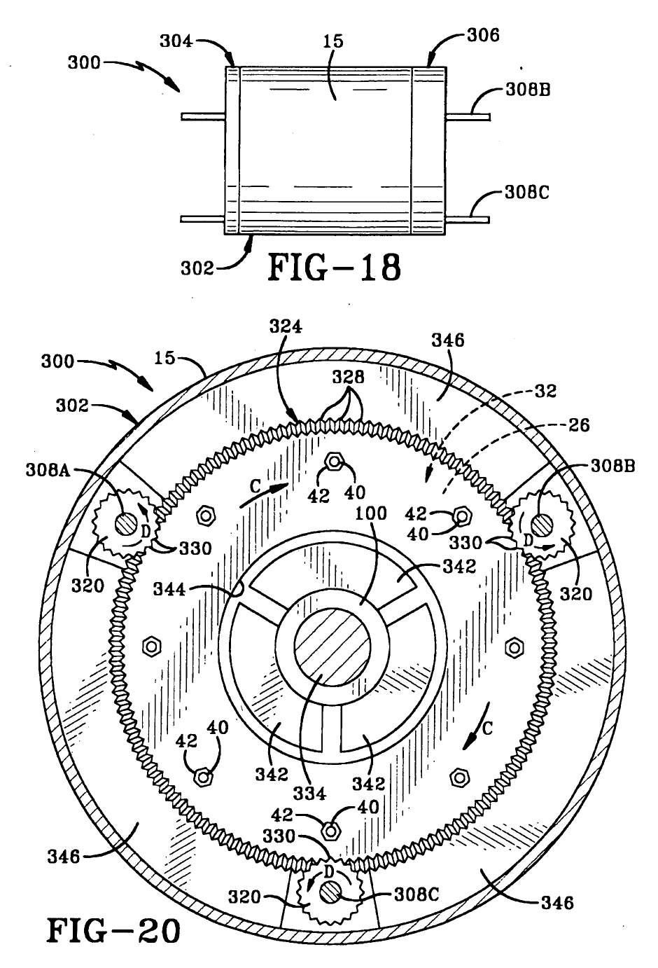

A first embodiment of the present invention is indicated generally at 10 in FIGS. 1-2; a second embodiment is shown generally at 200 in FIGS. 9-11; and a third embodiment is shown generally at 300 in FIGS. 18-20. Referring to FIG. 1, electric motor 10 includes a stator and a rotor wherein the stator includes a housing 12 and the rotor includes a rotatable output shaft 14. Housing 12 comprises a main cylindrical side wall 15 with first and second end sections 16 and 18 rigidly mounted thereon by a plurality of fastening rods 20 and nuts 22.

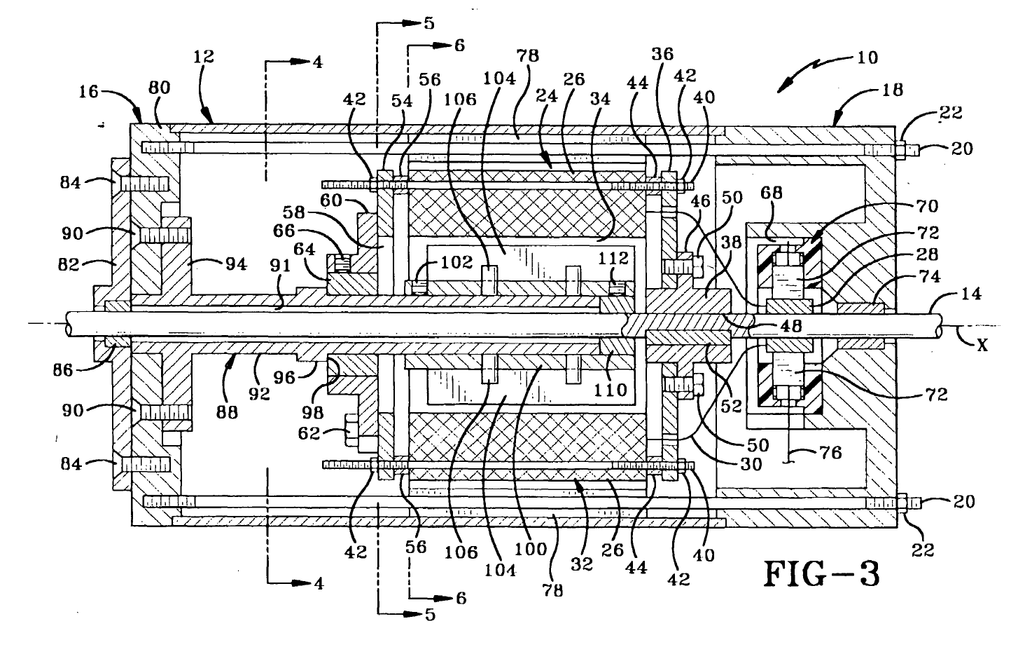

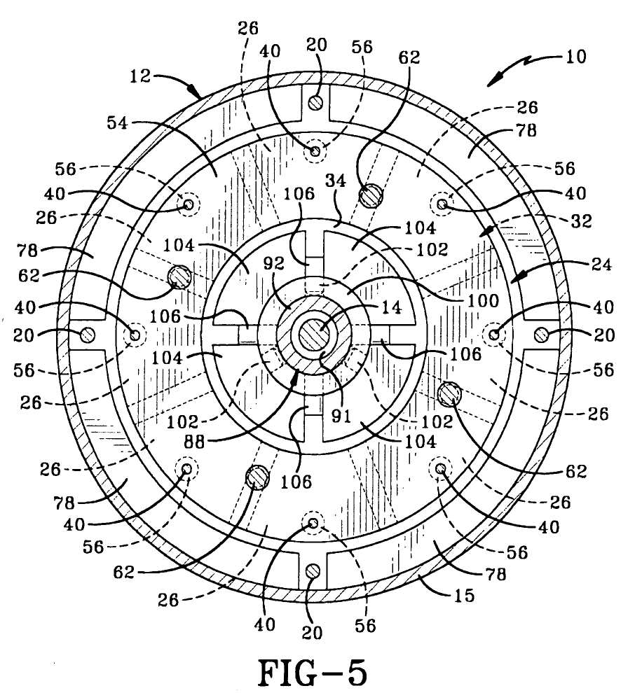

Referring to FIGS. 2-3, the rotor further includes a winding part 24 which includes a plurality of windings 26. The rotor further includes a commutator 28 and wires 30 which provide electrical communication between commutator 28 and windings 26. Windings 26 are mounted on a rigid annular armature 32 which defines a generally cylindrical interior chamber 34 (FIGS. 3 and 5). Armature 32 is rigidly mounted on shaft 14 via a mounting structure which includes a mounting plate 36 and an inner mounting member 38. Armature 32 is connected to plate 36 via a plurality of mounting rods 40 which are threaded on either end and threadably engaged by nuts 42. Armature 32 and plate 36 are spaced from one another by a plurality of spacers 44. Mounting member 38 includes an annular flange 46 which extends outwardly from a cylindrical body defining a bore 48 which receives shaft 14. Plate 36 and member 38 are joined to one another via a plurality of bolts 50 which pass through respective holes formed in flange 46 into threaded holes in plate 36. Shaft 14 and member 38 define respective key ways in which a key 52 is disposed to help prevent relative rotation between the two members. An annular plate 54 is secured to armature 32 on the opposite end from plate 36 via rods 40 and nuts 42. Plate 54 is spaced from armature 32 via a plurality of spacers 56 through which rods 40 respectively pass. Plate 54 defines a cylindrical through passage 58 having substantially the same diameter as that of interior chamber 34 and is substantially concentric therewith. A bearing-carrying mounting member 60 is rigidly connected to plate 54 via a plurality of threaded bolts 62. Mounting member 60 defines a recess which receives therein a bearing 64 which is secured to member 60 by a threaded member 66.

With continued reference to FIGS. 2 and 3, the remaining parts of the stator are further detailed. End section 18 defines an interior recess 68 in which is seated a brush assembly 70 comprising a plurality of brushes 72 in electrical communication with commutator 28. A bearing 74 is also mounted on section 18 and defines a passage through which output shaft 14 passes by which shaft 14 is rotatably mounted on section 18. Input wires 76 are in electrical communication with brushes 72 and an electrical power source (not shown) for receiving current therefrom for powering motor 10. Four arcuate magnets 78 (FIGS. 3-5) are mounted on the cylindrical inner surface of side wall 15 and equally spaced from one another with rods 20 passing respectively between adjacent magnets 78. Magnets 78 together form a first field part which produces a magnetic field in which windings 26 are disposed. End section 16 includes first and second end plates 80 and 82 which are secured to one another via threaded bolts 84. Plate 82 defines a recess for receiving therein a bearing 86 through which shaft 14 passes and by which shaft 14 is rotatably mounted about an axis X on plate 82. Plate 80 is secured to side wall 15 and end section 18 via threaded engagement between plate 80 and rods 20. A post member 88 is rigidly mounted on plate 80 via a plurality of threaded bolts 90. Post member 88 includes a hollow post 92 and an annular mounting flange 94 which extends radially outwardly from post 92 and threadedly engages bolts 90. Post 92 defines an elongated axially extending through passage 91 through which shaft 14 extends. A bearing seat 96 is axially spaced from flange 94 and extends radially outwardly from post 92 to provide a ledge 98 which is abutted by bearing 64 seated there against. Post member 88 includes a cylindrical sleeve 100 which is rigidly mounted on post 92 via threaded members 102 to provide a larger diameter outer surface on which a second set of four magnets 104 are rigidly mounted. Magnets 104 are arcuate so that an inner arcuate surface thereof fits in a mating fashion on the cylindrical outer surface of sleeve 100 and an arcuate outer surface of magnets 104 is disposed adjacent the inner cylindrical surface of armature 32. Magnets 104 are disposed within interior chamber 34 of armature 32 and thus provide an additional magnetic field in which windings 26 are disposed. Magnets 104 are equally spaced from one another, which may be simply achieved using optional spacers 106 which are inserted in corresponding holes 108 formed in sleeve 100. If desired, an additional bearing 110 may be mounted on post member 88, for example within the end of sleeve 100 via a threaded member 112.

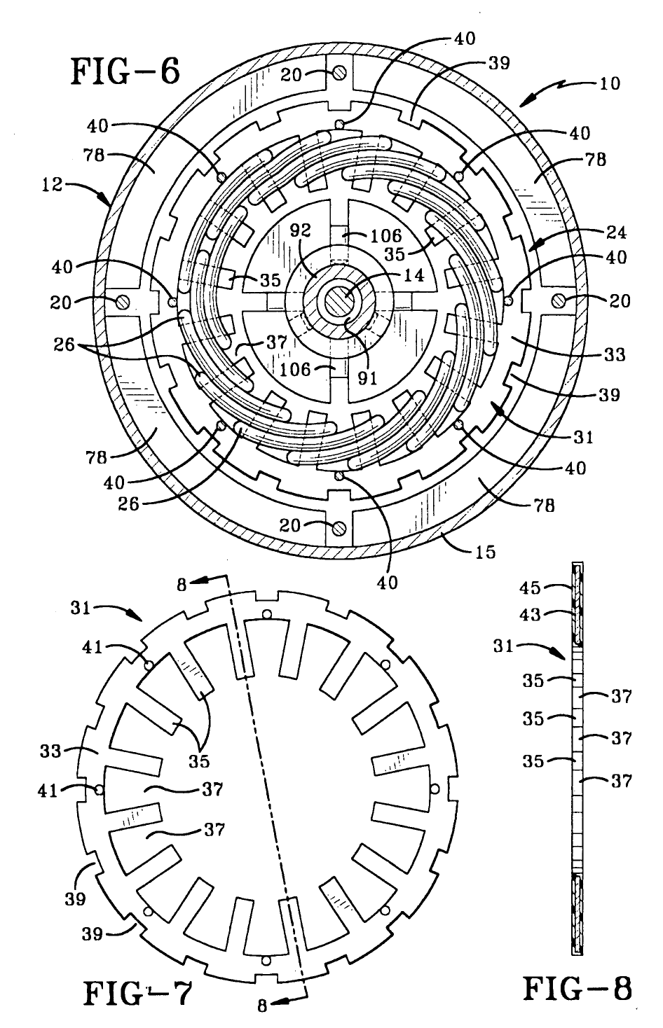

Referring to FIGS. 7 and 8, armature 32 includes a plurality of laminations 31 which are substantially flat plates stacked in abutment with one another and held together by rods 40 and nuts 42. Each lamination 31 includes a circular ring 33 and plurality of fingers 35 extending radially inwardly therefrom to define between each adjacent pair of fingers 35 respective winding-receiving spaces 37. Cutouts 39 are formed along the outer circumference of ring 33 opposite spaces 37. Holes 41 are formed in ring 33 adjacent every other space 37 for receiving therethrough rods 42. As shown in FIG. 8, each lamination 31 is formed of a flat metal plate 43 with a coating or layer 45 of paint or other electrically nonconductive material which completely encases plate 43. FIG. 6 shows how windings 26 are typically wound around fingers 35 within spaces 37.

In operation, an electrical current is passed through windings 26 via input wires 76, brush assembly 70 and wires 30. This flow of current within the magnetic fields produced by magnets 78 and magnets 104 causes the rotation of the rotor, which in this case includes winding part 24, shaft 14 and the other elements connected thereto. More particularly, shaft 14 rotates relative to the stator of motor 10 via bearings 64, 74, 86 and 110. Depending on the specific configuration and size of the various parts, it is contemplated that only two bearings may be necessary. However, it has been found in certain circumstances that a third bearing such as bearing 64 may be required in order to provide sufficient stability to winding part 24, which without such a bearing would essentially be mounted in a cantilever configuration via plate 36 and member 38. If needed, an additional bearing such as bearing 110 may also be provided for additional stability. Due to the use of the two sets of magnets 78 and 104 as described herein, the degree of torque for the amount of input current is substantially greater than that of a standard motor. It is noted that rods 40 are relatively long and thin and thus are formed of a high strength material in order to withstand the substantial torque produced by motor 10.

Motor 10 has been described as a DC motor in which magnets 78 and 104 are permanent magnets. However, magnets 78 and 104 also represent electromagnets in which the magnetic field thereof is created by passing an alternating current through windings represented at 78 and 104 instead of permanent magnets. In this case, a source of alternating current would be in electrical communication with windings 26, 78 and 104 in order to pass an alternating current therethrough. Motor 10 thus also represents an AC motor configuration.

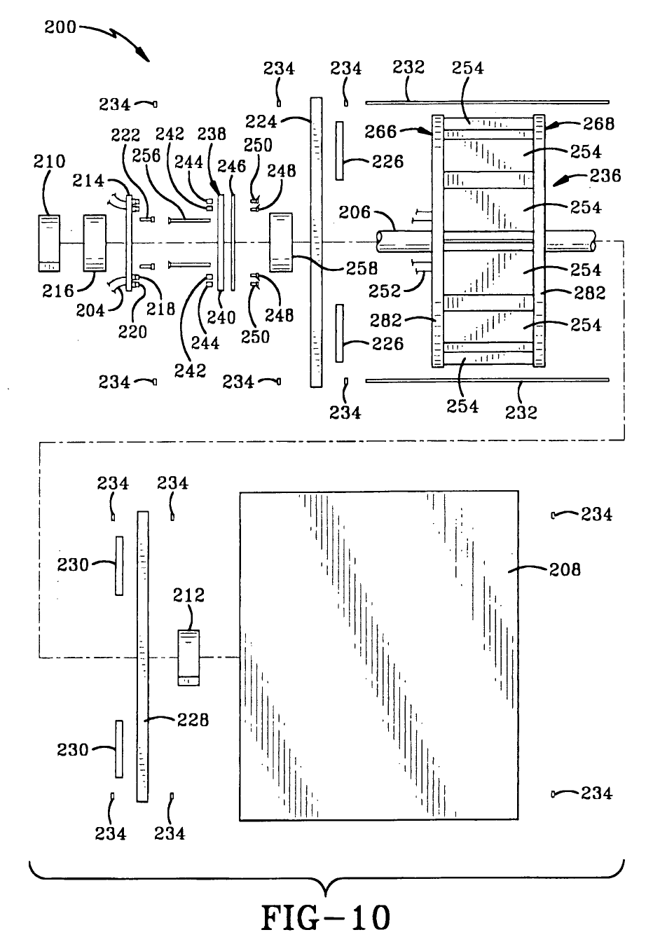

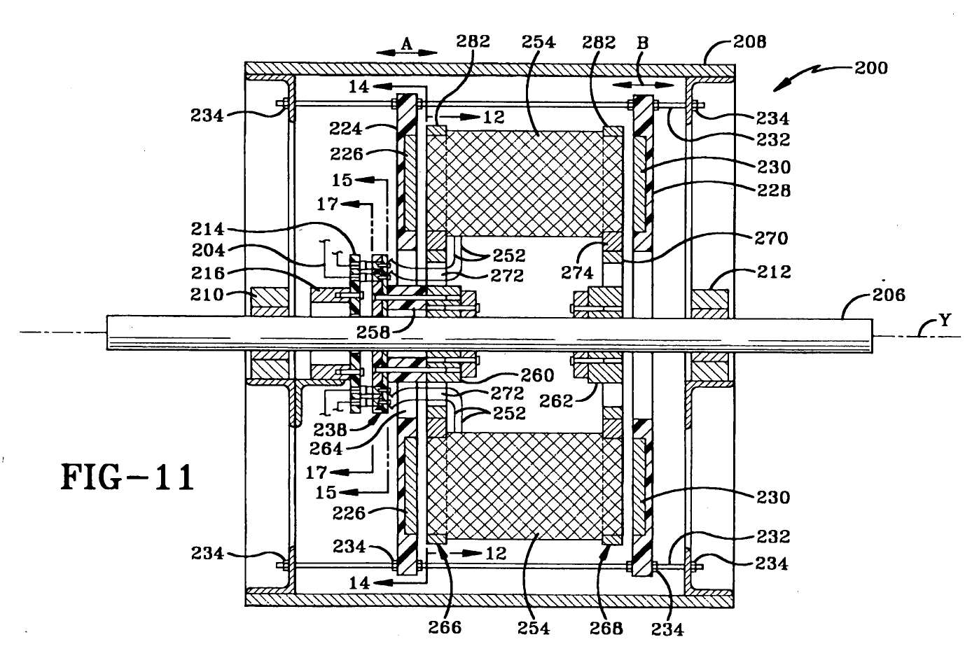

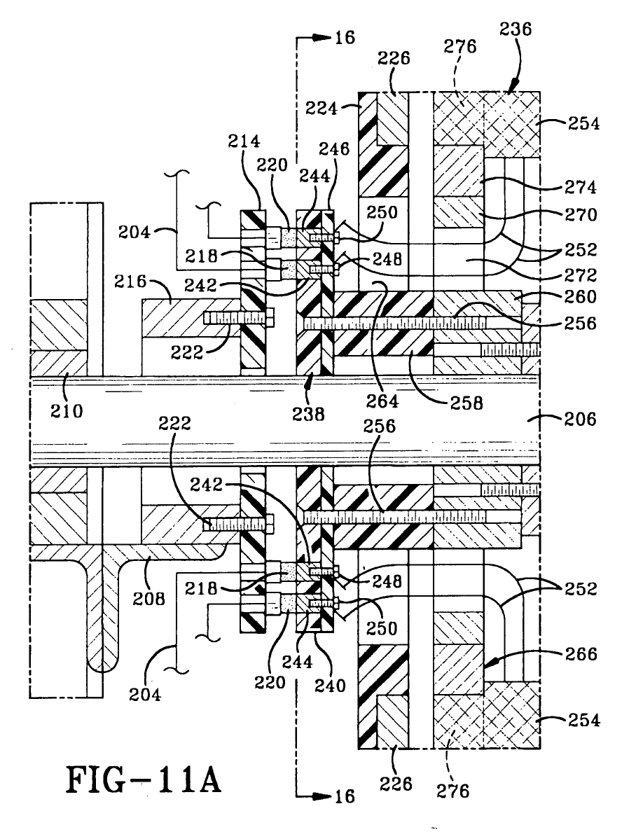

Motor 200 is now described. Referring to FIG. 9, motor 200 is powered by an electric power source 202 via input electrical wires 204 in order to cause the rotation of a rotational output shaft 206 which is rotatably mounted on a frame or housing 208. Referring to FIGS. 10-11, shaft 206 is rotatably mounted about an axially extending axis Y (FIG. 11) on first and second bearings 210 and 212 which are axially spaced from one another and secured to housing 208. A brush assembly 214 is mounted via an annular brush mount 216 on frame 208 with shaft 206 passing through each of assembly 214 and mount 216. Assembly 214 includes a plurality of inner brushes 218 and a plurality of outer brushes 220 which are in electrical communication with power source 202 (FIG. 9) via wires 204. Assembly 214 is mounted on mount 216 by screws 222. Also mounted on housing 208 is a flat first magnet holder 224 on which a plurality of magnets 226 are mounted to form a first field part. Likewise, a flat second magnet holder 228 is mounted on housing 208 with a plurality of second magnets 230 mounted thereon to form a second field part. More particularly, holders 224 and 228 are mounted on housing 208 by a plurality of threaded rods 232 and a plurality of nuts 234 threadably mounted thereon. As shown in FIG. 8, the mounting of first holder 224 via threaded rod 232 and nuts 234 allows for the axial adjustment of holder 224 as indicated at arrow A. Likewise, this mounting also allows for the axial movement of second holder 228 as indicated at arrow B in FIG. 11. Magnets 226 and 230 are thus easily positioned at the desired location.

Rigidly mounted on and rotatable with shaft 206 are a field part or armature 236 and a disc shaped commutator 238. Commutator 238 includes a disc shaped contact holder 240 and a plurality of inner and outer electrical contacts 242 and 244 mounted thereon within recesses formed therein. Another disc shaped member 246 abuts holder 240 with a plurality of inner and outer electrical leads 248 and 250 extending through holes formed therein to threadably engage inner and outer contacts 242 and 244. Leads 248 and 250 thus help secure contact 242 and 244 and also serve as electrical leads or connectors which are connected to respective wires 252. Wires 252 are in electrical communication with a plurality of windings 254 mounted on armature 236. Commutator 238 and member 246 are connected to armature 236 via screws 256 which pass through holes formed therein and through holes formed in an annular mount 258 and into the threaded holes formed in a first armature mount 260 which is rigidly connected to shaft 206. Armature 236 is also rigidly mounted on shaft 206 by second armature mount 262 which is axially spaced from first mount 260. Mount 258 serves as a spacer for spacing commutator 238 and member 246 axially from armature 236 in order to provide sufficient space therebetween to accommodate first magnet holder 224 so that holder 224 does not contact any of these rotatable members. Also to that effect, holder 224 defines a central opening 264 (FIGS. 11,14) in which mount 258 is disposed so that holder and mount 258 are out of contact with one another.

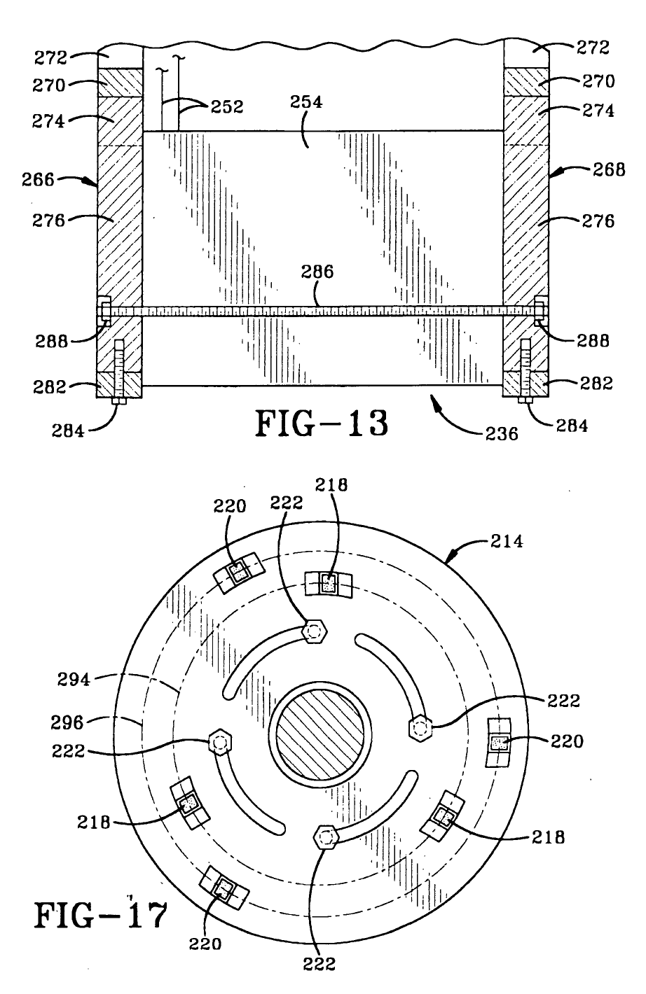

Referring to FIGS. 11 and 12, first and second axially spaced mounting wheels 266 and 268 are respectively secured to mounts 260 and 262 and extend radially outwardly therefrom for mounting therebetween windings 254. Each of mounts 260 and 262 serve as inner hubs on which are mounted intermediate hubs 270 defining plurality of openings 272 through which wires 252 pass. Each of mounting wheels 266 and 268 includes a spoked wheel having an annular hub 274 surrounding and connected to intermediate hub 270 and a plurality of spokes 276 extending radially outwardly from hub 274. Each adjacent pair of spokes 276 define therebetween a space in which is received one end of a winding core 278 around which a respective windings 254 is wound. In one preferred embodiment, cores 278 are made out of a plurality of flat steel plates positioned in a layered fashion. Hub 274 is connected to hub 270 by a plurality of threaded fasteners 280. Each wheel 266 and 268 further comprises a retaining ring 282 which circumscribes and is connected to the outer free ends of spokes 276 via a plurality of screws 284. Rings 282 also respectively circumscribe opposed ends of cores 278 to help retain cores 278 in place during rotation of armature 236. As shown in FIG. 13, wheels 266 and 268 are secured to one another by a plurality of threaded rods 286 each extending between a respective pair of spokes 276 of each wheel and mounted with respective nuts 288 on either end thereof.

In the exemplary embodiment, there are 12 spokes 276 on each mounting wheel for mounting thereon 12 winding cores 278 and 12 windings 254. Each of windings 254 is equally circumferentially spaced. As shown in FIG. 14, each field part includes three magnets 226 which are equally spaced circumferentially from one another, and spaced equally outwardly from shaft 206. Each of holders 224 and 226 are formed typically of a plastic capable of operation under relatively high temperatures. However, other non-metallic and non-magnetic materials may be used.

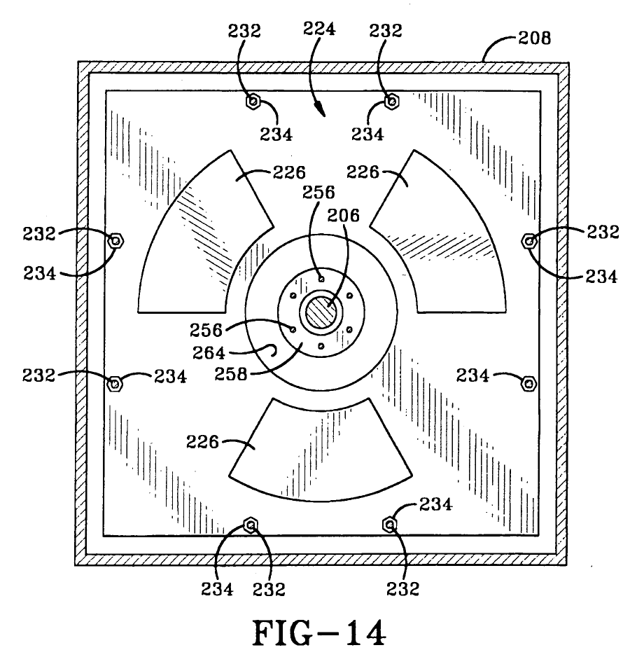

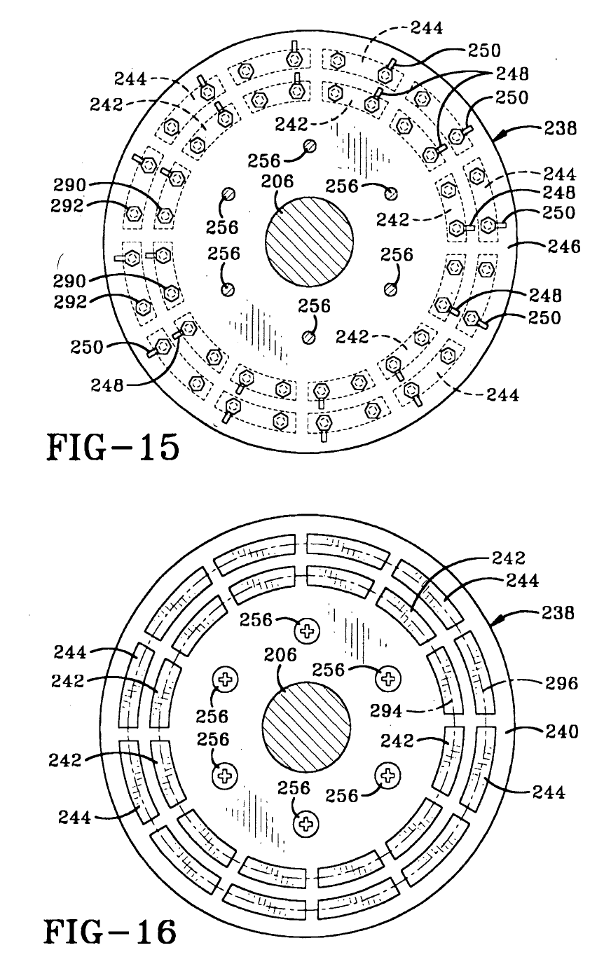

FIG. 15 shows member 246 in greater detail with leads 248 and 250 connected respectively to inner and outer contacts 242 and 244. FIG. 15 also shows additional inner and outer threaded fasteners 290 and 292 which further secure inner and outer contacts 242 and 244 to member 246. As shown in FIG. 16, there are 12 inner contacts 242 which are equally circumferentially spaced and which lie along an inner circle 294. FIG. 16 also shows that there are twelve outer contacts 244 disposed radially outwardly of contact 242 and which lie along an outer circle 296 of greater diameter than that of circle 294. As shown in FIG. 17, there are three inner brushes 218 which are equally spaced circumferentially from one another and which lie along circle 294. FIG. 17 also shows that are three outer brushes 220 likewise equally circumferentially spaced and which lie along circle. 296. While FIG. 16 shows that each pair of inner and outer contacts 242 and 244 are aligned along a common radius, FIG. 17 shows that each pair of inner and outer brushes 218 and 220 are circumferentially offset from one another to lie along separate radii extending outwardly from shaft 208.

In operation, electric power source 202 is switched on to provide electric power via wires 204 to brushes 218 and 220. An electrical current thus flows via brushes 218 and 220 through contacts 242 and 244, leads 248 and 250 and wires 252 through windings 254. The current going through lines 254 within the magnetic fields of magnets 226 and 230 causes armature 236 and output shaft 206 to rotate along with the other members connected thereto about axis Y. The provision of two field parts each comprising a plurality of magnets producing magnetic fields in which windings 254 are disposed provides rotational torque of output shaft 206 which is substantially greater than that of a standard motor for a given amount of electrical input. As noted with regard to motor 10, motor 200 may also be configured as an AC motor. Thus, magnets 226 and 230 may be formed as electromagnets with windings through which an alternating current is passed to produce the magnetic field instead of using permanent magnets.

Motor 300 is now described with reference to FIGS. 18-20. Motor 300 is similar in some regards to motor 10 and includes a housing 302 with a cylindrical sidewall 15 and first and second end sections 304 and 306 connected at either end of sidewall 15. Unlike motor 10, motor 300 has three output shafts 308A-C which extend therethrough and outwardly of either end through respective holes 310 formed in end plates 312 and 314 respectively of sections 304 and 306. Each output shaft 308 is rotatably mounted on end plates 312 and 314 by respective bearings 316 and 318. First and second beveled pinions 320 and 322 are secured to each output shaft 308 and spaced from one another within housing 302. Pinions 320 and 322 are positioned adjacent and laterally outwardly of armature 32. First and second beveled gears 324 and 326 are secured to armature 32 adjacent opposite ends 323 and 325 thereof and have teeth 328 which mesh with or matingly engage with teeth 330 of each pinions 320 and 322. The engagement between the frustoconical pinions and gears serves to suspend rotatable winding part 24 and the gears within housing 302.

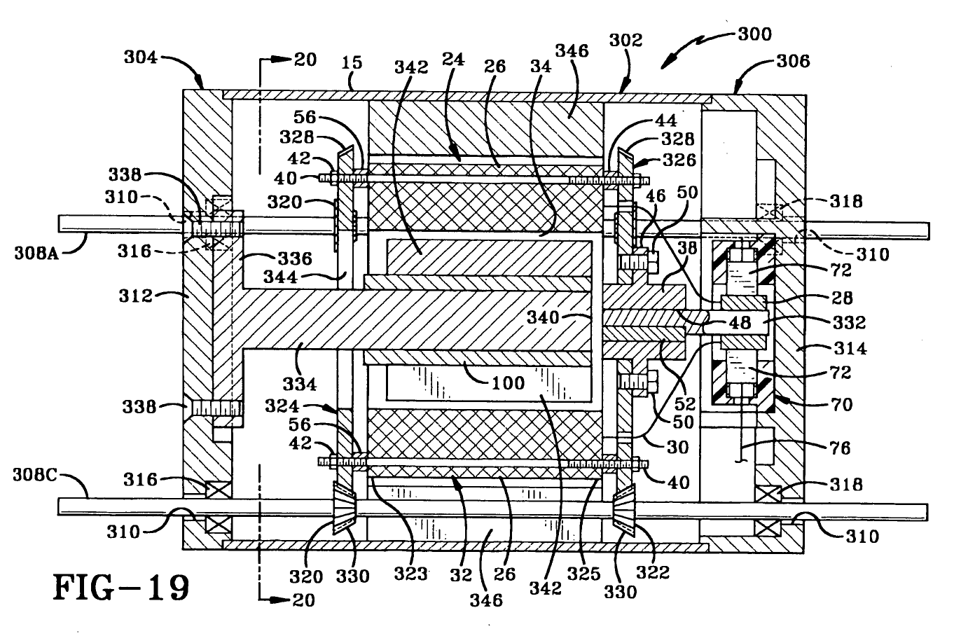

End section 306 and various structures in that region of motor 300 are similar to end section 18 and analogous structures of motor 10 with some exceptions. Thus, motor 300 includes brush assembly 70, brushes 72, wires 76 and 30 and other structure indicated by the numbering shown in FIG. 19. However, instead of having an output shaft like shaft 14 of motor 10 which extends in the center of the motor all the way through the housing, motor 300 has a rod or shaft 332 which is substantially shorter than that of shaft 14 and is disposed entirely within housing 302. Shaft 332 extends from adjacent end plate 314 to adjacent end 325 of armature 32 which is closest to end plate 314. Shaft 332 is secured to second gear 326 in the same manner shaft 14 is secured to mounting plate 36 of motor 10 although the specific structure may vary. Indeed, different configurations for a brush assembly may be utilized which are within the scope of the present invention. In the exemplary embodiment, shaft 332 is not supported by bearings on housing 302 but rather is supported entirely by the engagement between pinions 320, 322 and respective gears 324 and 326. While there is obviously engagement between brushes 72 and commutator 28, this plays an insignificant role in terms of supporting armature 32, gears 324 and 326, shaft 332 and the related structure secured together therewith.

A magnet-mounting post 334 is disposed within housing 302 and extends into interior chamber 34 within armature 32. A mounting flange 336 extends radially outwardly from post 334 adjacent one of its ends so that post 334 is cantilevered from end plate 312 via the connection of flange 336 to plate 312 via mounting screws 338. Post 334 has a free or terminal end 340 within interior chamber 34 adjacent second end 325 of armature 32. Sleeve 100 is secured to post 334 and extends from terminal end 340 to adjacent first end 323 of armature 32. Three internal arcuate magnets 342 are secured to sleeve 100 in a manner similar to magnets 104 of motor 10. Magnets 342 are disposed in interior chamber 34 so that windings 26 are within the magnetic field created by magnets 342. Post 334 extends through a passage 344 defined within gear 324. Passage 344 preferably has a diameter larger than that of magnets 342 in combination so that magnets 342 may be received through passage 334 during assembly and disassembly. Unlike motor 10, the exemplary embodiment of motor 300 is free of bearings connected to post 34 for the mounting either of an output shaft or the mounting of the rotor which includes armature 32 and gears 324 and 326. Thus, motor 300 is free of structure directly between gear 324 and post 334 in a direction normal to post 334. However, if desired or needed for stability, a bearing and associated structure such as bearing 64 of motor 10 may be used between gear 324 and post 334. In addition, if desired or needed, a bearing such as bearing 74 of motor 10 may be used to mount shaft 332 to end plate 314. Three external arcuate magnets 346 are mounted on housing 315 on the inner curvatures of sidewall 15 in a manner similar to magnets 78 of motor 10 and are disposed radially outwardly of armature 32 adjacent the outwardly facing annular surface of armature 32.

In operation, an electric current is passed via wires 76, brushes 72, brush assembly 70, wires 30 and windings 26 so that the electromagnetic field produced by windings 26 interacts with the magnetic fields of internal magnets 342 and external magnets 346 in order to cause rotation of winding part 24 about a central axis as indicated at arrows C in FIG. 20 to drive rotation of pinions 320 and shafts 308 in the opposite direction (Arrows D) via the interaction between the teeth of the pinions and gears. Thus, the rotational movement of gears 324 and 326 is translated to the pinions 320 and 322 which have a much smaller diameter than that of gears 324 and 326. Motor 300 thus provides for three output shafts 308 which can be accessed at either end of the motor in order to provide rotational drive for any suitable purpose.

While the exemplary embodiment of motor 300 utilizes three output shafts with the associated pinions, this number may vary. While the number of output shafts may be greater than three, it may also be only one as long as the winding part 24 is properly supported within housing 302. While the engagement between the teeth of the gears and pinions or a similar type of engagement provide for a positive drive therebetween, it is also contemplated that support rollers may engage a smooth circular outer surface of winding part 24 or a structure attached thereto in order to suspend the winding part within the housing so that it is centered during rotation while also providing the positive drive between at least one gear and one pinion mounted on the output shaft. In addition, it was earlier noted that different brush assemblies and commutators may be used in a motor similar to motor 300. For instance, the commutator and brushes may be positioned at a diameter substantially greater than that shown in the exemplary embodiment so that a passage is formed through the commutator or structure holding the electrical contacts of the commutator so that a post similar to post 334 may be mounted on end plate 314 to support one end of internal magnets 342, or a post may extend in a continuous manner from end plate 312 to end plate 314 through the commutator and brush assembly in order to support the internal magnets within interior chamber 34 of armature 32. As previously noted with the earlier embodiments, magnets 342 and 346 may be electromagnets in order to provide for an AC motor configuration. Further, each of motors 10, 200 and 300 may be configured as brushless motors when desired.

Thus, motors 10, 200 and 300 each provide a substantial improvement over the known prior art motors which utilize but a single field part and thus produce a greater degree of torque for a given electrical input.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An electric motor comprising:
a stator;
a rotor rotatable relative to the stator;
a winding part mounted on one of the stator and rotor and comprising an armature with a plurality of windings thereon;
an annular outer surface on the winding part facing radially outwardly;
an annular inner surface on the winding part facing radially inwardly;
a first interior chamber defined by the annular inner surface;
a first field part comprising a first set of magnets in the first interior chamber providing a magnetic field in which the windings are disposed;
a second field part comprising a second set of magnets positioned radially outwardly of the annular outer surface providing a magnetic field in which the windings are disposed; and
wherein the field parts are mounted on the other of the stator and rotor.

2. The motor of claim 1 further comprising an output shaft mounted on the rotor and rotatable therewith; first and second spaced bearings contacting the stator and the output shaft by which the output shaft is rotatably mounted on the stator; and a third bearing contacting the stator and rotor without contacting the output shaft.

3. The motor of claim 2 wherein the stator comprises a hollow member which abuts the third bearing and defines a passage in which the output shaft is disposed.

4. The motor of claim 3 wherein the first field part is mounted on the hollow member.

5. The motor of claim 4 wherein the stator comprises a sidewall defining a second interior chamber in which the winding part and the field parts are disposed; and an end wall connected to the sidewall; and wherein the hollow member is connected to the end wall and extends therefrom into the second interior chamber.

6. The motor of claim 5 wherein the hollow member is connected to the end wall in a cantilever fashion and extends therefrom into the second interior chamber to a free end thereof; and further comprising a fourth bearing connected to the output shaft and the hollow member adjacent its free end.

7. The motor of claim 2 wherein the third bearing is disposed between the first and second bearings.

8. The motor of claim 2 further comprising a fourth bearing connected to the output shaft and the hollow member within the first interior chamber.

9. The motor of claim 1 further comprising a commutator in electrical communication with the winding part; and a brush assembly in electrical communication with the commutator and adapted for electrical connection to an electric power source.

10. The motor of claim 1 further comprising an output shaft mounted on the rotor and rotatable therewith; a first flange connected to and extending radially outwardly from the output shaft to the winding part so that the winding part is rotatable with the output shaft and first flange.

11. The motor of claim 10 further comprising a second flange spaced from the first flange, extending radially inwardly from the winding part and rotatable therewith; and a bearing connected to the second flange and extending radially inwardly therefrom to connect to the stator.

12. The motor of claim 11 further comprising an output shaft mounted on the rotor and rotatable therewith; and wherein the bearing defines a passage through which the output shaft passes without contacting the bearing.

13. The motor of claim 1 further comprising an output shaft mounted on the rotor and rotatable therewith about an axially extending axis; an axially extending post; and an axially elongated passage formed in the post in which the output shaft is disposed.

14. The motor of claim 13 wherein the first field part is mounted on the post.

15. The motor of claim 14 further comprising a second interior chamber formed in the second field part; and wherein the winding part is disposed in the second interior chamber.

16. The motor of claim 1 further comprising a post extending from inside to outside the first interior chamber; and wherein the first field part is connected to the post.

17. The motor of claim 1 further comprising an output shaft mounted on the rotor and rotatable therewith; and a bearing mounted on the stator and rotor and defining a passage through which the output shaft passes without contacting the bearing.

18. The motor of claim 1 further comprising a bearing connected to the rotor and stator within the first interior chamber.

19. The motor of claim 18 wherein the rotor comprises an output shaft; and wherein the bearing is connected to the output shaft within the first interior chamber.

20. The motor of claim 19 wherein the stator comprises a hollow member which extends into the first interior chamber and defines a passage in which the output shaft is disposed; the first field part is connected to the hollow member; and the bearing is connected to the hollow member.
